(19) United States
(12) Patent Application Publication
(10) Pub. No.: US 2014/0082569 A1
(43) Pub. Date: Mar. 20, 2014

(54) Security System and Methods For Portable Devices

(71) Applicant: Steven Robert Borgman, Houston, TX (US)

(72) Inventor: Steven Robert Borgman, Houston, TX (US)

(21) Appl. No.: 13/621,640

(22) Filed: Sep. 17, 2012

(51) Int. Cl. G06F 3/00

(52) U.S. Cl. 715/863

(57) ABSTRACT

A portable communications or computing device includes one or more sensors for detecting motion in the x, y, and z axes, and/or pitch, yaw, and roll, and/or magnetic direction, and includes hardware and software programmed to allow a user to use one or more motions of the portable device as a security feature such that such motions are needed in order to gain access to the functionality of the device or data stored in memory of the device. A display provides prompts allowing the user to choose to include one or motions of the device as security, and allows the user to include such one or more motions of the device alone or in combination with one or more alphanumeric characters as a password to restrict access to the functionality of the device and/or data stored in memory on the device. Such motions can be selected from preset motions. Such motions can be used to provide varying levels of security for selected data or other files or functionality of the device.

### CROSS-REFERENCE TO RELATED APPLICATION

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### FIELD OF THE INVENTION

The present invention relates to systems and methods for providing security for personal computing devices and portable communications devices, including without limitation security systems and methods useful in connection with use with cellular telephones, smartphones, tablets, personal computers, and the like.

### BACKGROUND OF THE INVENTION

Personal communications and computing devices include a wide variety of items, including cellular telephones, smartphones, cameras, music and video players, tablets, and personal computers, among other things. A number of different companies make and sell a variety of such devices under a variety of trademarks, including iPods, iPhones, and iPads, all available from Apple, Inc., as well as competitive products from a variety of companies.

Such devices often may include communications capabilities, including for voice and/or data communications, including text messaging, emails, facsimiles, and the like. In addition, such devices may include web browser software for browsing Internet websites. Such devices often include the ability to download a wide variety of files from the Internet or other sources, including without limitation files including text, pictures, videos, music, spreadsheets, and the like.

As consumers use more and more such devices, the use of the same to store and transmit valuable information has increased. For example, individuals may store tax returns, bank statements, credit card receipts, passwords for bank accounts, savings and retirement accounts, and the like. In addition, valuable personal information may include personal health information, as well as other private information, such as personal correspondence and the like.

As a result of the use of personal communications and computing devices to store more and more private and valuable personal information, it has become important to provide for methods and systems to secure such information. Conventional approaches to provide security for such devices include the use of user names and passwords. Doing so provides some security but a determined thief can usually remove the hard drive or other storage device and recover the information therefrom. Hard drives can be encrypted with a variety of algorithms, but doing so often slows down or hinders the use of the data stored thereon.

Conventional security approaches for smartphones, cellular telephones, music and video players or recorders, cameras, and tablets, however, usually involves a password consisting of a limited number of digits. A password comprising only four numerals provides less security than a password with a greater number of permutations. Even if alphabetical characters are added, such that alphanumerical passwords are provided, a shorter password still provides less security than may be desired. For example, if a smartphone is stolen, the thief will likely have access to the device for an extended period of time during which the thief can apply software to try to crack any security code used. To protect the information on the device in such situations, it is desirable to make it as difficult as possible for the thief to crack the password.

In conventional security approaches for portable communications and computing devices (such as smartphones, music and video players, and tablets), a four-digit security code can be optionally adopted by the user. If the user chooses, the device allows the user to select a four-digit code as a password before allowing access to the device's functionality and the information stored on the device. In addition, conventional devices provide for a lock-out if there have been a number of unsuccessful attempts to enter a security code (which tends to indicate that the person entering the incorrect security code is not the owner or authorized user). As noted, a four-digit code limited to numerals provides only limited security to the device and the information stored thereon.

In one alternative approach, the device may be configured with hardware and software to automatically detect the application of a force to the device which exceeds a preset threshold. Such a force may indicate that someone is attempting to remove a hard drive or other storage medium from the device, which may tend to indicate that a thief has obtained the device and is trying to gain access to the information stored thereon. In such an approach, the device may be configured to enter a prevention mode in which access is restricted and to send a signal to a remote location to indicate the device's location and that it may be stolen. Such an approach is described in U.S. Pat. No. 7,825,820, which issued on Nov. 2, 2010, to Lee, and is hereby incorporated by reference herein.

In yet another approach to providing security for such devices, software and hardware is included in such a device to provide an alarm if a theft condition is detected. In U.S. Published Patent Application No. 2005/0190059, published on Sep. 1, 2005, which is incorporated by reference herein, an acceleration sensor is used to detect acceleration, with software provided to determine if a theft condition is present. In such a situation, the device also has software and hardware that provides an alarm, such as a loud noise.

A number of conventional portable communications and computing devices have one or more accelerometers or other sensors. Such sensors may include one or more gyroscopes capable of determining location and motion in x, y, and z dimensions, as well as pitch, yaw and roll. In addition, a magnetometer can be provided, which can sense the local magnetic direction relative to the earth's poles. Such portable devices include hardware and software that detects data such as motion and movement in the x, y, and z dimensions, pitch, yaw and roll, and stores data relating to such motion in memory, and uses such information to perform other functions, such as automatically rotating the display of information on such devices when the devices are rotated, such as by changing the display from a portrait view to a landscape view, and the like. An example of such a device is disclosed in U.S. Pat. No. 7,688,306, issued to Wehrenberg et al. on Mar. 30, 2010, which is incorporated by reference herein. Such sensors may be used to provide limited security features such as those noted above, as well as in connection with power management schemes as disclosed in U.S. Pat. No. 7,873,849, issued to Mucignat et al. on Jan. 18, 2011, which is incorporated by reference herein.

Such conventional portable devices, however, nonetheless do not make full use of the functionality of the hardware and software for detecting motion, and do not use such functionality and information for providing greater security for such devices. In Wehrenberg et al., for example, it is noted that an accelerometer may be used to detect whether a portable device has been moved according to certain directions in order to determine whether a password has been entered correctly. However, Wehrenberg et al. fails to provide any disclosure which allows a user to select a user defined movement or motion to provide part or all of a password for the portable device.

### SUMMARY OF THE INVENTION

The present invention relates to systems and methods for providing security for personal computing devices and portable communications devices, including without limitation security systems and methods useful in connection with use with cellular telephones, smartphones, tablets, personal computers, and the like.

In accordance with one embodiment of the invention, a portable communications or computing device includes a computer readable storage medium with software stored thereon, with the software programmed to be responsive to signals from a gyroscope, one or more accelerometers, a proximity sensor or other sensors included in such device for detecting motion, so that a user may optionally use one or more movements of such device as a security feature to control access to some or all of such device's functionality and/or some or all of the information and data files stored in memory in such device. The one or more movements of such device can also be optionally used in combination with one or more numeric or alphanumeric characters or security codes to control access to such device and its functionality or the information stored therein. The portable device in accordance with one embodiment comprises software programmed to allow a user to choose whether or not to include at least one movement of the device as a security feature and whether or not to combine such a movement with one or more alphanumeric characters as a password to restrict access to one or more data files or functions of the device. The device includes software programmed to provide a prompt to the user to choose to use a movement of the device as a security feature, then move the device in at least one direction, and store the data corresponding to the at least one movement of the device in non-volatile memory. In one particular embodiment, when a user then chooses to power on the device the next time, for example, the software is programmed to prompt the user to repeat the previous movement of the device, the device detects the movement of the device and then compares the data from such movement to the data stored in non-volatile memory for the previous movement of the device to determine whether or not the most recent movement is a match to the previous movement. If there is a match, then access to the device and/or some or all of its functions and data is no longer restricted; if there is no match, then the functions or data files to which access is restricted remain restricted. In other embodiments, multiple movements of the device may be used, and the movements can be used alone or in combination with alphanumeric characters to provide for multiple levels of security protection, such as by using only one movements of the device for gaining access to certain functions and/or data files, and using multiple movements in a particular sequence for gaining access to other functions and/or data files of the device. In still another embodiment, a portable device is provided with certain preset patterns of movement stored in memory, and the device is programmed to allow a user to select one of several such preset patterns of movement as a motion password.

In yet another embodiment, a security system is provided which is couple to an ignition system of an automobile (or other vehicle for transportation) so that the ignition system is disabled unless a user moves a device such as a car key or key fob in a pattern corresponding to a movement password. In yet another embodiment of the invention, a small device or card is provided which enables access to physical facilities once a user has moved the device or card or the like in a pattern corresponding to a movement password.

It is an object of the invention to provide enhanced security for controlling access to a portable communications or computing device.

It is a further object of the invention to provide enhanced security features for controlling access to a portable communications or computing device without the need for additional hardware.

It is a further object of the invention to allow a user more flexibility in connection with the security features that a user may implement for controlling access to a portable communications or computing device.

It is also an object of the invention to provide a system to provide security for an automobile by selectively enabling an ignition system.

It is also an object of the invention to provide a system for controlling access to physical facilities, such as rooms, offices, buildings, and the like.

These and other further objects of the present invention and the preferred embodiments thereof will be apparent to those skilled in the art from the above and from the following detailed description of embodiments.

### BRIEF DESCRIPTION OF THE DRAWINGS

FIG. 1 is a view of a portable communications device in accordance with one embodiment of the invention.

FIG. 2 is a flow diagram in accordance with one embodiment of the invention for the entry of a motion password to enable security and restrict access to the device.

FIG. 3 is a flow diagram in accordance with one embodiment of the invention for the entry of a motion password to gain access to a device and disable security.

FIGS. 4A-4D are diagrams showing displays on a portable communications device in accordance with one embodiment of the invention.

FIGS. 5A-5D are diagrams showing movements of a portable communications device in a plurality of directions.

### DETAILED DESCRIPTION

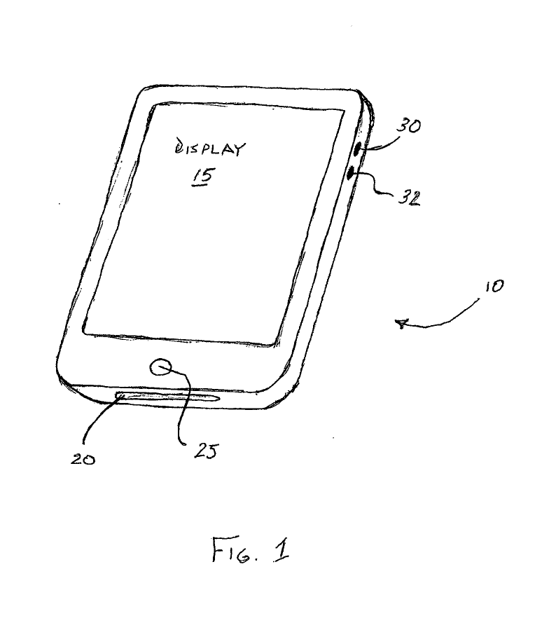

In FIG. 1, a conventional portable communications device 10 is shown. For convenience, it can be an iPhone, such as those commercially available from Apple, Inc. of Cuppertino, Calif. Those skilled in the art will appreciate, however, that the portable device could easily be one of many types of devices from a variety of manufacturers, such as cellular telephones, smartphones, tablets (such as the iPad, which is commercially available from Apple, Inc. of Cuppertino, Calif.), portable music and video players (such as the iPod, which is commercially available from Apple, Inc. of Cuppertino, Calif.), and the like. The device 10 includes hardware and software, including a processor, memory, and an operating system. In addition, the device 10 may include one or more accelerometers, a gyroscope, a proximity sensor and other sensors to automatically detect location and movement of the device 10 in the x, y, and z dimensions. These sensors can provide signals to the hardware and software of device 10 so that as device 10 is moved in any direction, such motion is detected and tracked, with the data corresponding to such motion stored in non-volatile memory. It will be understood that such sensors can be used to track the movement of the device in the x, y, and z directions and can also be used to determine and measure pitch, yaw and roll, as well as the distance the device has travelled in any given direction during a given time interval.

In addition to the hardware and software described above, the device 10 may include a telephone, including transceiver circuitry, a camera for both still and video images, a music player, a video player, a display, the ability to provide user input, such as a keypad or touch pad, as well as other input and output means, such as USB drive connection ports, as well as a battery or other power supply. Such a device can also have a motherboard, including a central processor unit (CPU), random access memory, as well as non-volatile memory, such as NAND or NOR flash memory.

As shown in FIG. 1, the device 10 includes a display 15, which may comprise a touch screen or other type of display, such as conventional LCD or LED types of displays. The display 15 preferably comprises a touch screen, such as a capacitive touch screen, although other displays may be used. In addition, controls 25, 30 and 32 are provided. Controls 25, 30 and 32 can be of any conventional type, such as buttons responsive to a human touch or other movement, and may be located in any position on the case of device 10 as may be desired. Those skilled in the art will appreciate that it may be useful to separate control 25 from controls 30 and 32, such that controls 30 and 32 may be used in tandem, such as in the manner explained in more detail below. In addition, device 10 may be provided with a port 20 as shown in FIG. 1. The port 20 may be of a conventional standard, such as for a USB connection or the like, or may be of a proprietary type. The port 20 may be useful for input/output of files to be stored in or retrieved from the memory of device 10.

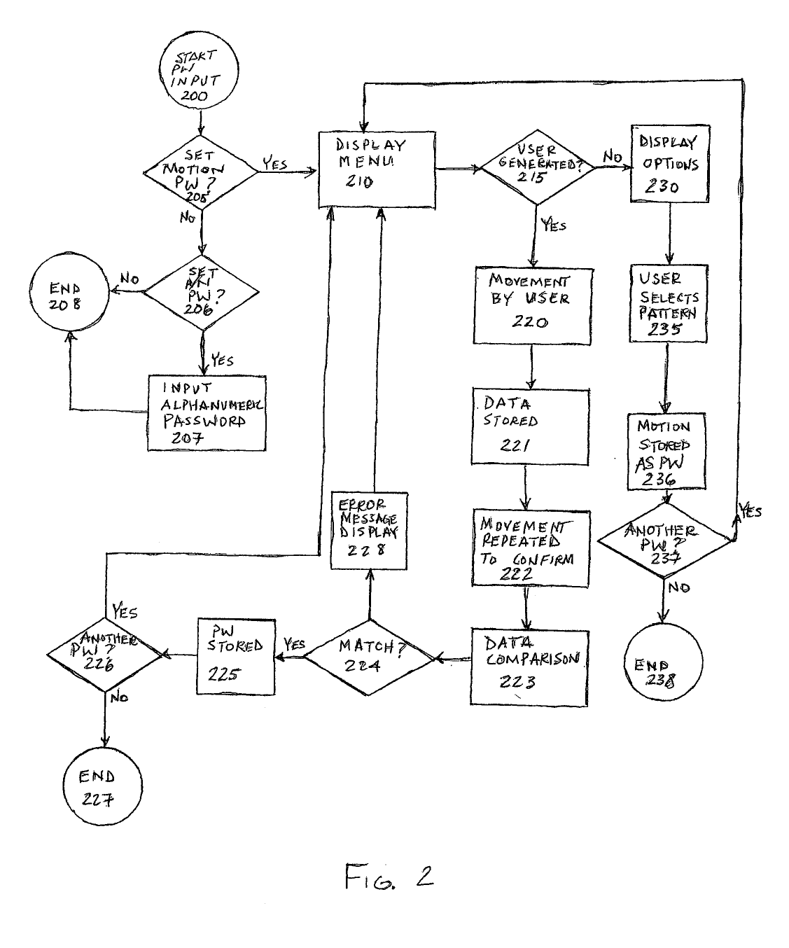

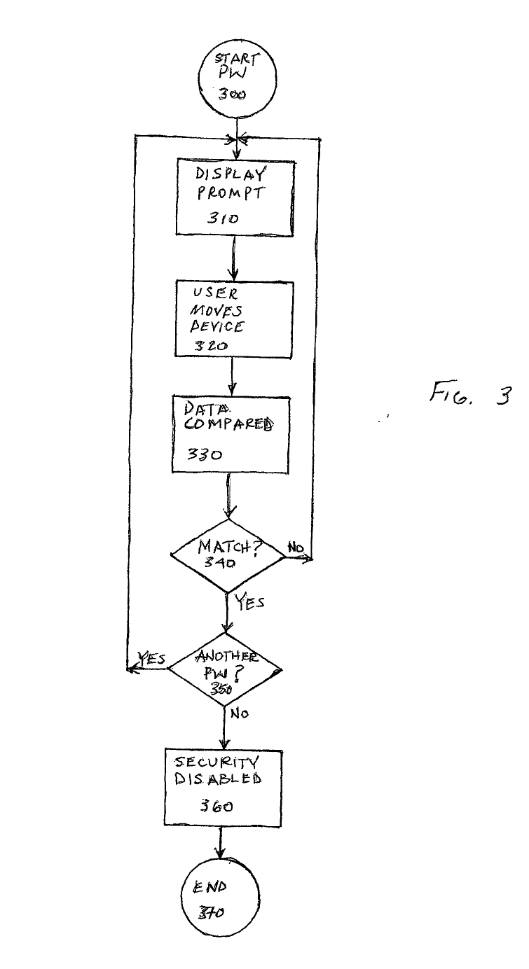

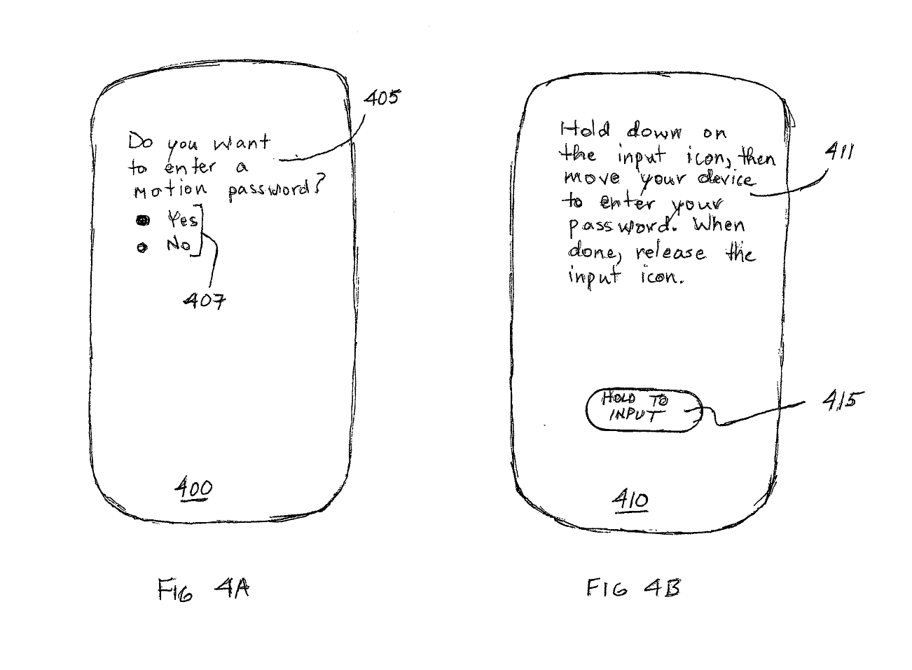

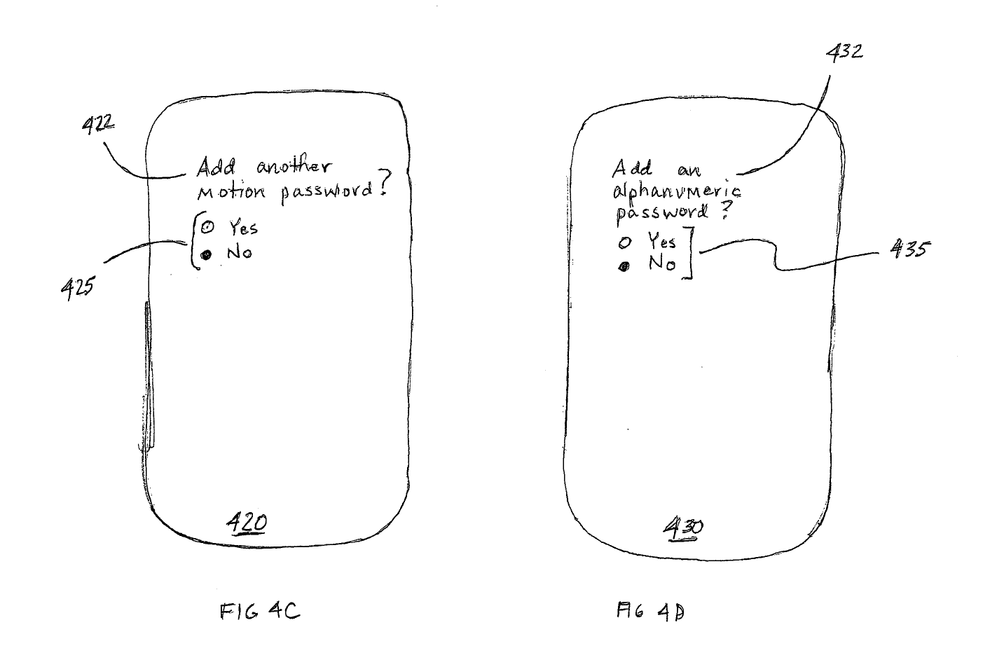

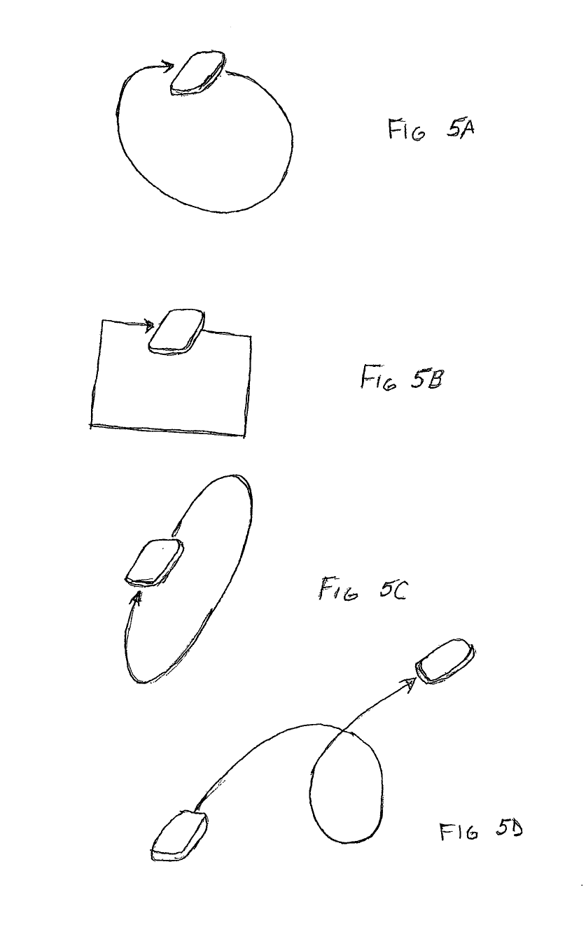

Referring now to FIG. 2, a flow diagram is provided which shows and describes an embodiment of a method for providing password protection for a portable device using one or more movements of the device. In step 200, the start of the logic flow for the input of a motion password is shown. In step 205, a user is prompted to select an option to implement a password for a portable device 10. In response, the device 10 provides a display at step 210 in which the display provides the user with an option for motion passwords. As shown in FIG. 2, if the user declines to set a motion password, the software proceeds to step 206, where the user is prompted to choose whether to set an alphanumeric password. If the user declines to do so, the password setting process ends at 208. If the user chooses to set an alphanumeric password, the user does so at step 207 and, once the alphanumeric password is set, the process ends at 208. (Because the use of one or more numerals alone as a password is conventional, the input and use of such alphanumeric passwords is not discussed in detail herein. Instead, the following discussion focuses on the input and use of a password using one or more motions of the device 10, alone or in combination with other data.)

If the user responds to the prompt in step 210 by indicating that the user wishes to use one or more motions of the device 10 as a password, the software on the device 10 then moves to the step 215 of motion password input. In step 215, the user chooses whether to set a user-generated motion password or to set a password based on one or more predefined motions of device 10. If the user chooses to select from one or more predefined motions of device 10, the process moves to step 230, where the device 10 displays the predefined movements of the device which may be selected. At step 235, the user selects one or more of the predefined movements, such as by pressing any of controls 25, 30, or 32 as instructed by the display 15 of device 10. Once the user has selected a predefined password, that selection is stored in memory of device 10 and the password protection is enabled. Alternatively, the device 10 can be programmed to prompt a user to then move the device 10 in accordance with the user's selected motion password. The device 10 can measure such movement of device 10 and determine the extent to which the user's movement deviates from the selected motion. For example, if the user selects a circular motion, but then moves the device 10 in an elliptical shape, the device 10 can measure this difference. The device 10 can be programmed so that, depending on such difference, the user's selection is stored and used as noted, the movement selected can be altered to reflect the actual movement of device 10 by the user, or the error margins for acceptance of the motion password can be automatically increased or decreased depending on how closely the actual movement tracks the selected motion.

Still referring to FIG. 2, if the user chooses to create a user-generated motion password, at step 215, the device 10 first displays instructions to the user on the display of device 10. Next, the device 10 waits for the user to input a first movement of the device. In one embodiment, the user indicates the beginning of the first motion password by touching the display 15 of the device 10 in a location indicated on the display 15, then continuing to maintain contact with the display of the device 10 while moving the device 10 in the desired manner at step 220. Once the user has finished the desired movement of the device 10 for the first motion password, the user so indicates by ceasing contact with the display of the device 10. The device 10 then stores the relevant data relating to the first motion password (e.g., movement in the x, y, and z axes, pitch, yaw and roll, and distance travelled during the motion, and the like) in non-volatile storage at step 240. The device 10 then provides a display to the user at step 250 indicating that the device 10 has successfully stored the data relating to the first motion password and asks the user to confirm that the user wishes to use the first motion of the device 10 as a password required to gain access to the functionality of the device 10 and the files stored in memory of device 10. In response to an affirmative confirmation from the user, the software installed on device 10 enables password protection at step 260 so that, when the device 10 is in a protected state (such as after being turned on), the user must enter the first motion password in order to gain access to the functionality and data of the device 10.

In the alternative, and as shown in FIG. 2, once the data corresponding to the movement of the device 10 is stored as in step 221, the software executing on device 10 may prompt the user to confirm the motion password by repeating the movement of the device 10 at step 222. The device 10 then waits for the user to confirm the user-generated password by waiting for the user to repeat the motion of the device 10. The device 10 then collects the data corresponding to the movement of the device 10 and, at step 223, compares the data collected for password confirmation to the data collected from the initial movement of the device 10 at step 220. If the two data sets provide a sufficiently close match, then the user is deemed to have confirmed the user-generated motion password as shown by step 224 and the data corresponding to the movement is stored in non-volatile memory as the password and the password protection of device 10 is enabled at step 225. If, however, the movement during the confirmation step generates data sufficiently at odds with the data provided by the movement of the device at step 220, then no match is found at step 224, and the software then generates and error message display as shown at step 228. As shown in FIG. 2, once an error has been detected, the software then starts the motion password setting process at step 210, which provides the user with a menu of options for a motion password. As shown in FIG. 2, the software can be programmed so that, once a user inputs and confirms a motion password, the user may choose to input and implement a second (or perhaps third, fourth, or even more) password. At step 226, the display 15 of the device 10 prompts the user to indicate as to whether an additional password is to be set. If the user responds in the negative, then the password setting process is complete and ends at 227. If, however, the user chooses to set another password, then the software is programmed to return to the display menu at step 210, from which the user may choose to implement a second user-generated password or from one of several predefined motions as a password. Thus, the software provided on device 10 allows the user to select to implement a combination of user-generated and/or predefined motions as one or more motion passwords for the device 10.

Those skilled in the art will appreciate that the motion password or motion passwords can be combined with one or more alphanumeric passwords in addition to one or more motion passwords. Additionally, those skilled in the art will appreciate that the above process can be varied in a number of ways. For example, instead of continuously contacting the display 15 while inputting a motion password (e.g., while moving the device 10), the software executing on device 10 can be programmed so that the user may press button 30 to begin the input and then press button 32 to indicate that the movement of device 10 is complete. Alternatively, the user may press button 25 to begin the data input process and then press button 25 to indicate the completion of the movement of device 10.

With respect to the predefined movements that may be selected by the user, those skilled in the art will realize that any one of number of movements with varying complexities may be provided as options with the data corresponding to such movements stored in non-volatile memory of device 10. For example, such movements could include movements such as those describing a two-dimensional figure such as a square, circle, triangle, heart, diamond, or the like, or a three-dimensional object or pattern, such as a spiral. In addition, any one of a number of movements, such as those like the letters “Z” or “C”, or the numbers “3” or “7”, or any other letters or numbers, may be provided as predefined motions for passwords.

Those skilled in the art will understand and appreciate that the foregoing description of the entry of a motion password can be repeated so that a user can input a plurality of motion passwords. In such a situation, the data corresponding to each of the motion passwords can be obtained and stored in non-volatile memory by repeating essentially the same steps as described above.

Referring now to FIG. 3, a method of providing a motion password to gain access to a device 10 is shown. In FIG. 3, it is assumed that a user has already input a first motion password to secure the device 10, has turned the device 10 off, and has now turned the device 10 on. When the device 10 is powered up, such as when it is turned on from an off state at step 300, the software installed on the device 10 at step 310 checks to see if a password has been previously set. If not, the device 10 continues with normal operation and without any security protection. If a password has been set, however, the device 10 then checks at step 320 to see if the password includes one or more motion passwords. If the password includes one or more motion passwords, then the software moves to step 330 to provide a display to the user to prompt entry of the motion password.

The device 10 then waits for the user to enter the motion password. In this particular embodiment, the user may enter the motion password in the same manner as the motion password was first entered. Thus, the display on device 10 at step 340 prompts the user to touch a particular location on the display (such as on a touch pad display or a button, for example) and maintain contact at such location or with such button while the user then repeats the motion of the device 10 that was used as the motion password. Once the motion has been completed, the user ceases contact with the particular location of the display. The device 10 then stores the data relevant to the motion of the device 10 while the user maintained contact with the display and, at step 350, compares this data to the previously stored data for the motion password. If the new data provides a sufficiently close match to that stored for the motion password, then the device 10 at step 360 provides a display indicating that the entry of the motion password was successful and also disables the restrictions on access, thus providing the user with access to the functionality and data of the device 10. In addition, the device 10 can be programmed so that if the second repetition of the movement for the motion password is sufficiently different from the first repetition, the device 10 will display a prompt indicating that the match, while sufficiently close, nonetheless has variations and asks the user if the user wishes to repeat the movement or wishes to alter the matching criteria to be used by the software (such as by allowing a 20% difference in the data from a movement made to enter the password versus a 10% difference). The device 10 can also be programmed so that the stored data for the movement password averages the data input from the two repetitions of the movement for the password and the confirmation of the movement password for comparison to data collected from future login attempts using the movement password.

Those skilled in the art will understand and appreciate that, if a user has chosen to implement two or more motion passwords, the steps described above for the entry of the motion password can be repeated until such time as the user has successfully input all of the motion passwords. Although not shown, those skilled in the art will understand and appreciate that the foregoing description of the setting of a motion password and its entry in order to unlock a device and gain access can be modified to further include the entry of one or more numerals or alphanumeric characters.

Further, a user may choose to mix the combinations of such numeric or alphanumeric passwords with one or more motion passwords. For example, a user could input first a motion password, then a four-digit numeric password, and then a second motion password. Once such a combination of passwords has been entered and stored, the user would need to enter the first motion password, then the four-digit numeric password, and then the second motion password in that sequence to disable security and gain access to the functionality of the device 10 and/or the files stored in memory of the device 10.

Those skilled in the art will also understand and appreciate that a user is unlikely to repeat a movement of the device 10 with exactly the same distances, degrees of angular rotation, and the like. For example, it is unlikely that the data stored in step 320 in connection with the input of a motion password as shown in FIG. 3 will be an identical match with the data stored in step 221 when the user first enters the motion password, as shown in FIG. 2. Nonetheless, it is likely that the same person will enter the motion password to unlock the device 10 and therefore will likely come close to repeating the movement of the device 10 when the motion password was first entered. To account for such likely variation, a match can be deemed to occur when only minor variations in the data are found during the data comparison steps 223 and/or 330. Thus, the comparison steps 223 and/or 330 can provide a matching result when the data differences do not exceed certain parameters, thresholds, or tolerances. For example, a user may intend to include a 90 degree turn in the movement of the device 10, but may only actually turn the device 10 by 85 degrees when first inputting and setting the motion password, then actually turn the device 10 by 95 degrees when inputting the motion password to gain access. In such a case, the actual movements vary by 10 degrees and the data will differ accordingly. Nonetheless, the software can be programmed to provide a match.

Those skilled in the art will understand and appreciate that the software can be programmed to provide a match even though the data for the motion password may vary as much as 15% or more from that stored in memory as the password. Those skilled in the art will further appreciate that the device 10 can be programmed to allow a user the option of selecting either greater or lesser precision in terms of the differences between the data sets in terms of finding a match. By requiring greater precision, and thus allowing fewer differences in the data, such as 10% or less, a user may therefore implement greater security by making it more difficult to repeat the motion password. By allowing for less precision and thus greater differences in the data, such as 20% or more, the user may implement a lower level of security and allow for the easier repetition of the motion password.

In another embodiment of the system and methods of the invention, the device 10 can be provided with the data corresponding to certain preset movement patterns stored in memory. In addition, the device 10 can be programmed to prompt the user to determine whether or not to use one of such preset patterns as a password and to display the alternative movement patterns. If the user chooses this option, the user then selects one of the preset movement patterns and the data corresponding to such movement is stored in memory as the password. Such preset movement patterns could include simple geometric shapes, such as a circle, a square, an equilateral triangle, a diamond, or the like. Such preset movement patterns could also be more complex, such as numbers or letters. For example, the preset movement patters could include the letter C, the letter T, the letter S, or other letters or numbers if desired. The preset movement patterns could further require or allow movement in three dimensions or only two; or could require that a two-dimensional pattern, such as a circle, be repeated to gain access, but nonetheless the software to compare the input movement to the selected preset movement can be programmed to recognize and treat a circular pattern in three dimensions the same as if it were completed in two dimensions.

In the case of such preset movements, the data stored can correspond to movements of specific size or can be more generalized. For example, with respect to a preset movement corresponding to a circle, the data corresponding to the circle could require that the circle be approximately one foot in diameter. In such a case, the display of the device 10 should indicate the size of the movement being selected. In addition, it may be desirable to require a user to repeat a preset movement in order to confirm that the preset pattern is indeed the movement that the user contemplates and that the user can repeat the same later to unlock the device 10. Alternatively, the preset patterns can be set so that no particular size is required for a match when the user repeats the movement. For example, instead of a one-foot circle as the motion password, the preset movement can simply require a circle. In such a case, the user might later move the device 10 in a one-inch circle to enter the motion password to unlock the device 10. In such a case, the one-inch circle, assuming that the circular pattern data provides a sufficiently close set of data to provide a match without regard to the size of the circle, should be accepted as the motion password to disable the security lock of the device 10.

In yet another embodiment of the invention, a movement password or security code can be implemented in connection with a key fob, a security card, or some other small device that can be easily carried in a pocket or purse. In such an implementation, the device can have a processor and memory containing software, as well as accelerometers and/or gyroscopes, such that the device can generate and store data corresponding to movement of the device in either two or three dimensions, as may be desired. The device can be configured so that it communicates wirelessly (such as via cellular, infrared, WiFi, or otherwise) with another device to send and receive movement password information. For example, the first device can be a key fob or included in a casing for an automobile ignition key, with the second device a receiver. In one implementation, the first device allows for the input of a movement password and stores it in memory. The second device can be programmed to recognize a signal from the first device, such as a signal indicating an electronic serial number of the first device or the like. The first device can be further programmed so that, upon successful entry of a motion password by a user, the first device sends an authentication signal to the second device which, when received by the second device, is recognized and used by the automobile to enable the ignition system. In such an embodiment, an additional level of protection against theft is provided. In addition, such a system may be used to make it harder for an impaired driver to start the automobile, such as when the driver has been drinking alcohol or is under the influence of other substances and has a loss of coordination or motor control. It will be appreciated that variations of this embodiment can be easily implemented, such as by implementing the security system in the ignition key, such that the ignition key is not enabled for starting the automobile unless the correct movement password is entered.

In yet another embodiment, a device can be a small fob or card can include one or more accelerometers and/or gyroscopes, as well as means for storing and transmitting the data corresponding to the device's movement. The device can be programmed so that the data is stored and transmitted to a receiving device, which then receives the data, compares it to a preselected data pattern, and then enables access to a desired facility if the data received corresponds to the data stored corresponding to a movement password. In one embodiment, the second device can be used to unlock a door to provide access to a secure room or facility, or to allow a user to pass through security, such as conventionally provided at many buildings, offices, and institutions. In yet a further embodiment, the fob or card can be programmed to store a user identification code or number, which is then transmitted with the movement data to the second device. In this manner, a particular user can be required to enter a particular movement (which can be selected from any one of a number of movements, such as geometric shapes, or which can be set by that particular user).

Those skilled in the art will understand and appreciate that the foregoing detailed description provides a detailed description of one or more embodiments of the invention and that the invention is not limited to or defined by the foregoing description, and that the scope and spirit of the invention is broader and defined by only the claims and not the foregoing description. Those skilled in the art will further understand and appreciate that the foregoing description merely provides examples, and that changes, amendments or modifications to the examples provided are within the scope and spirit of the invention.

I claim:

1. A portable computing device having software installed comprising instructions for performing the following steps:
providing a user with a display prompting a user to select whether or not to include at least one motion of the device as a security feature;
in response to a prompt from the user to include at least one motion of the device as a security feature, providing a prompt to the user to move the device in at least one direction;
detecting movement of the device in at least one direction;
storing information relating to the movement of the device in the at least one direction in memory;
restricting access to at least one feature of the device until the device is moved in manner corresponding to the at least one direction in response to a prompt to do so.

2. The portable computing device according to claim 1 wherein the device comprises a cellular telephone.

3. The portable computing device according to claim 1 wherein the device comprises a tablet.

4. The portable computing device according to claim 1 wherein the device comprises a music or video player.

5. The portable computing device according to claim 1 wherein the software instructions further comprise the steps of:
prompting a user to input at least on alphanumeric character; and
restricting access to at least one feature of the device until the at least one alphanumeric character is inputted in response to a prompt to do so.

6. The portable device according to claim 1 wherein the feature of the device comprises at least a data file stored in memory.

7. The portable device according to claim 1 wherein the feature of the device comprises at least one function of the device.

8. The portable device according to claim 1 wherein the feature of the device comprises at least one software application and at least one data file stored in memory corresponding to the at least one software application.

9. The portable device according to claim 6 wherein the at least one data file comprises financial information.

10. The portable device according to claim 1 wherein the software instructions further comprise the steps of:
detecting movement of the device in a plurality of directions;
storing information relating to the movement of the device in the plurality of directions in non-volatile memory; and
restricting access to at least one feature of the device until the device is moved in manner corresponding to the plurality of directions in response to a prompt to do so.

11. The portable device according to claim 1 wherein the software instructions further comprise the steps of:
detecting a plurality of movements of the device in a plurality of directions;
storing information relating to each of the plurality of movements of the device in the plurality of directions in non-volatile memory;
restricting access to at least one feature of the device until the device is moved in a manner corresponding to the plurality of movements in the plurality of directions.

12. A method for protecting information stored in memory in a portable computing comprising the following steps:
determining whether a portable device is in a restricted state;
if the device is in a restricted state, providing a user with a display prompting a user to move the device in a pattern in order to gain access to one of more files stored in memory of the device;
detecting movement of the device in at least one direction;
storing information relating to the movement of the device in memory;
comparing the information relating to the movement of the device to information previously stored in memory of the device that corresponds to a previous movement of the device by the user;
based on said comparing step, determining whether the movement of the device matches the previous movement of the device; and
if a match is found, enabling the device so that one or more files stored in memory of the device are not restricted.
